(19) United States
(12) Patent Application Publication
(10) Pub. No.: US 2007/0101586 A1
(43) Pub. Date: May 10, 2007

(54) Power tool with a duplicate switch

(75) Inventors: Sacha Felder, Langendorf (CH); Miguel Da Costa, Bellach (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/572,788

(22) PCT Filed: Jun. 28, 2005
(86) PCT No.: PCT/EP05/53038

§ 371 Date: Mar. 21, 2006

(30) Foreign Application Priority Data
Aug. 31, 2004 (DE) 10 2004 041 025.4

(51) Int. Cl. B23D 49/00

(52) U.S. Cl. 30/392

(57) ABSTRACT

With a power tool with a first operating switch for turning the power tool on and off, optimum operation of the power tool is achieved every time it is used by the fact that the power tool includes a second operating switch for turning the power tool on and off.

### BACKGROUND INFORMATION

The present invention is directed to a power tool with the features—that represent the general class—of Claim 1.

Power tools are generally known. Tools of this type always include an operating switch and/or an on/off switch, with which the power tool can be turned on and off. It is important that the operating switch be positioned correctly, so the power tool can be operated in an optimum manner. With known power tools, the operating switch is therefore located in a position on the tool where the switch can be easily reached by the operator during normal operation of the tool. If a known power tool of this type is not used by the operator in the normal, intended position, however, but rather in an unusual position, it is often difficult for the operator to reach the operating switch. This makes turning the tool on and off complicated and time-consuming.

### ADVANTAGES OF THE INVENTION

In contrast, a power tool according to the present invention having the features of Claim 1 has the advantage that a power tool is therefore created that is easy to turn on and off not only during normal operation, but also special operation when used in unusual positions. In particular, the power tool according to the present invention, with its second operating switch, enables easy switching on and off and, therefore, optimum usage when the power tool is used overhead.

The term “power tool” generally encompasses all tools that are electrically operated. In particular, the term refers to hand tools, i.e., tools that are operated and guided by hand. The power tool is preferably a jigsaw.

The first operating switch and the second operating switch of the power tool perform the same function. They are both used to turn the power tool on and off. The power tool according to the present invention can be started up or turned off using either the first or second operating switch. The first operating switch is preferably located on the power tool such that it is easy to reach during normal operation. The other operating switch, however, is preferably located such that it enables a convenient switching on and off of the power tool in a special operating position that is different from the normal operating position. The special operating position is preferably an overhead position, i.e., a position in which the power tool is rotated by 180° relative to the normal position, that is, it is used “upside-down”.

When the second operating switch is designed for overhead use, it is particularly advantageous when the first operating switch and the second operating switch are located essentially at right angles to each other. This means that the two planes formed by the respective operating switches form an angle of approximately 90° with each other. This angle can also preferably be slightly less than 90°.

In a particular embodiment of the present invention, the power tool can include a side handle and a top handle, the first operating switch being located on the side handle, and the second operating switch being located on the top handle. The side handle and top handle make it possible to hold and guide the tool. The top handle is mainly suited for guiding the power tool when used overhead.

The power tool according to the present invention is preferably designed such that the side handle and the top handle transition into each other, thereby essentially forming a right angle, the first operating switch and the second operating switch being located on diametrically opposed surfaces in this angle. With this design, the side handle and the top handle meet in the same region and transition into each other. During normal operation, the top handle is essentially vertical, while the side handle is essentially horizontal. In this case, the first operating switch and the second operating switch are located close to the transition region between the side handle and the top handle.

It is advantageous when the first operating switch and the second operating switch are coupled with each other, so that a motion of the first operating switch is transferred directly to the second operating switch, and vice versa. In particular, the first operating switch and the second operating switch can be mechanically coupled with each other via a flexible connecting element. The advantage of this is that only one device is required for both operating switches to convert the mechanical motion of the switch into an electrical variable. The flexible connecting element is preferably a thin strip of sheet metal seated in the angle formed by the side handle and the top handle. The first operating switch is preferably fastened to one end of the connecting element, and the second operating switch is preferably fastened to the second end of the connecting element, so that the first connecting element and the second connecting element are connected with each other “around the corner”, so to speak.

It is advantageous when the power tool includes a guide for the connecting element, so it can reliably transfer the motion of one switch to the other switch.

Finally, the first operating switch is preferably connected with an adjusting slide, the adjusting slide converting a motion of the first operating switch into an electrical variable. The adjusting slide is preferably designed as a long thin segment connected with the electronics of the power tool. When either of the two operating switches is operated, the adjusting slide is displaced, thereby turning the power tool on or off.

### DRAWING

An exemplary embodiment of the present invention is explained in greater detail in the description below with reference to the associated drawing.

FIG. 1 Shows a perspective full view of a jigsaw according to the present invention;

FIG. 2 Shows a perspective, enlarged partial view of the jigsaw according to FIG. 1;

FIG. 3 Shows the side of the jigsaw according to FIG. 1, in a partial view;

FIG. 4 Shows the side of the jigsaw according to FIG. 1, in a perspective partial view;

FIG. 5 Shows a perspective, side view of the jigsaw according to FIG. 1, without housing;

FIG. 6 Shows a full view of the jigsaw according to FIG. 1, in overhead use;

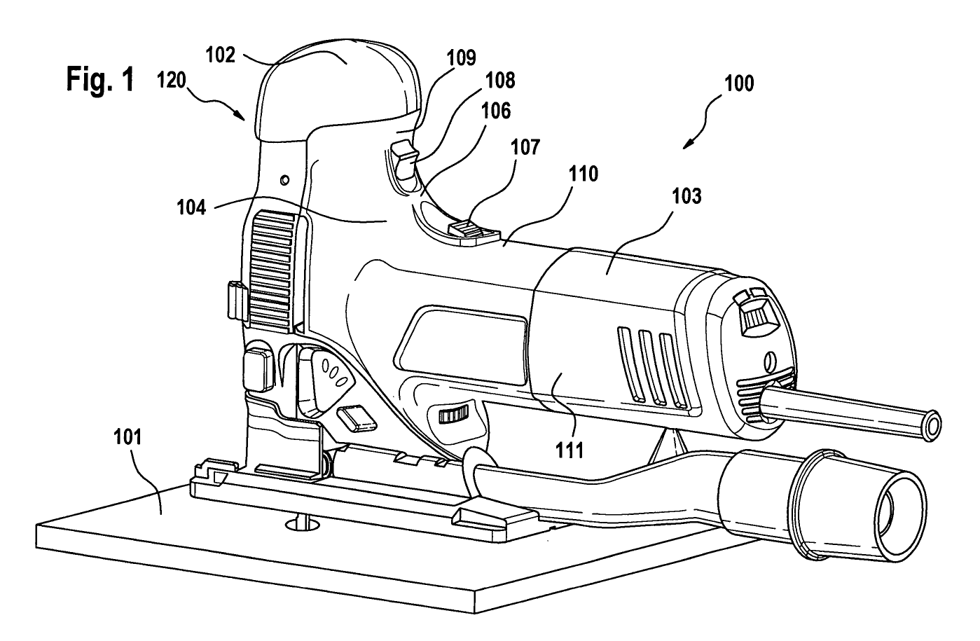

FIG. 1 shows a jigsaw 100 in a perspective full view. Jigsaw 100 rests on a workpiece 101 to be machined. Workpiece 101 can be, e.g., a board to be sawed. Jigsaw 100 includes a top handle 102 and a side handle 103. Top handle 102 and side handle 103 are essentially positioned at a right angle with each other. The two handles transition into each other in a transition region 104. A first operating switch 107 and a second operating switch 108 are located in angle 106, which is formed by two handles 102 and 103. The two operating switches 107 and 108 are located in a corner, so to speak. Considered together, first operating switch 107 and second operating switch 108 can also be referred to as a duplicate switch. Second operating switch 108 is located on a substantially vertical surface 109 of top handle 102. First operating switch 107 is located on a substantially horizontal surface 110 of side handle 103.

Jigsaw 100 also includes a shell-like housing 111.

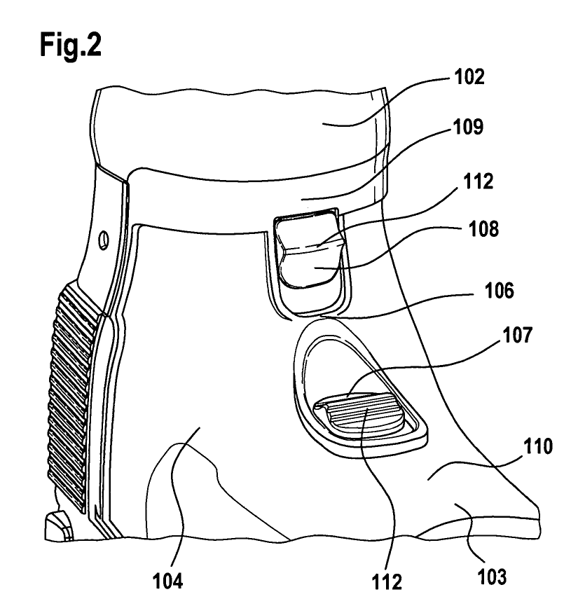

FIG. 2 shows a detained view of first operating switch 107 and second operating switch 108. The two switched are located “around the corner” from each other. Second operating switch 108 is located above first operating switch 107. Accordingly, first operating switch 107 can also be referred to as the bottom switch, and second operating switch 108 can be referred to as the top switch. The two operating switches each include one or more projections 112, with which they can be moved back and forth with the touch of a finger.

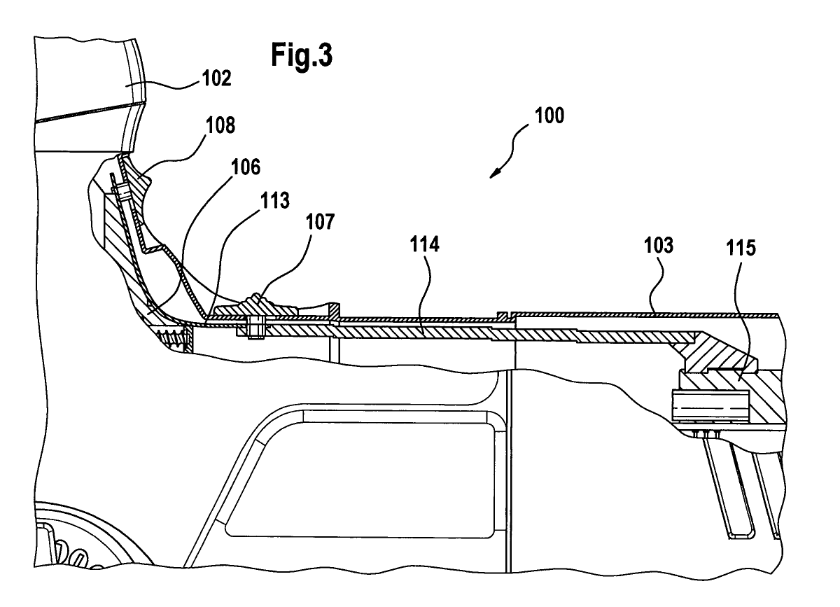

In FIG. 3, first operating switch 108 and second operating switch 108 are shown from the side. First operating switch 107 rests horizontally on side handle 103. Second operating switch 108 is located nearly vertically on top handle 102. The two switches are connected with each other via a sheet-metal connecting piece 113. Sheet-metal connecting piece 113 describes angle 106. Second operating switch 108 is fastened to the top end of sheet-metal connecting piece 113. First operating switch 107 is fastened to the other, lower end. Sheet-metal connecting piece 113 is guided in a flexible, clear manner. An adjusting slide 114 is connected with first operating switch 107 and with electronics 115 of jigsaw 100.

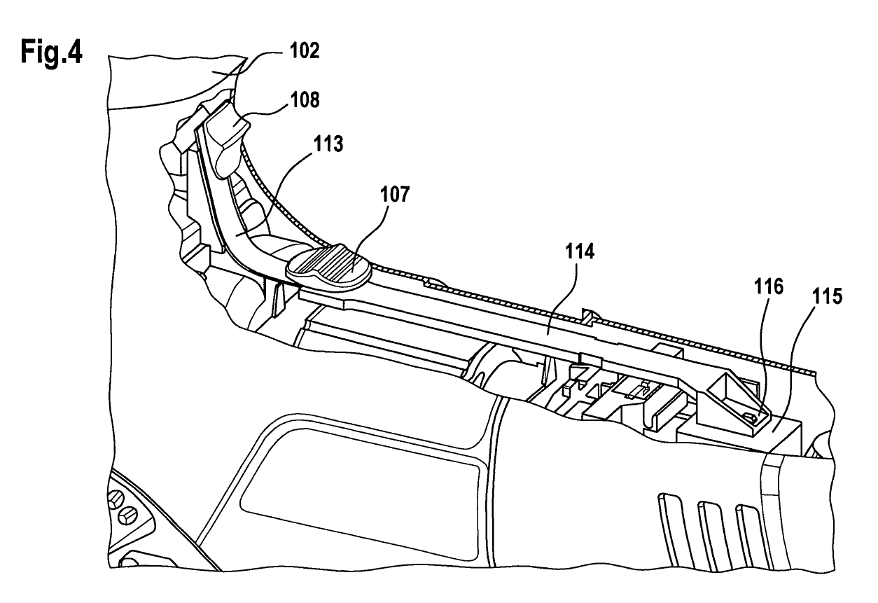

FIG. 4 is a perspective detained view. In this view, flexible, curved sheet-metal connecting piece 113 and adjusting slide 114 are easy to recognize. Adjusting slide 114 includes a front section 116, with which it engages with electronics 115.

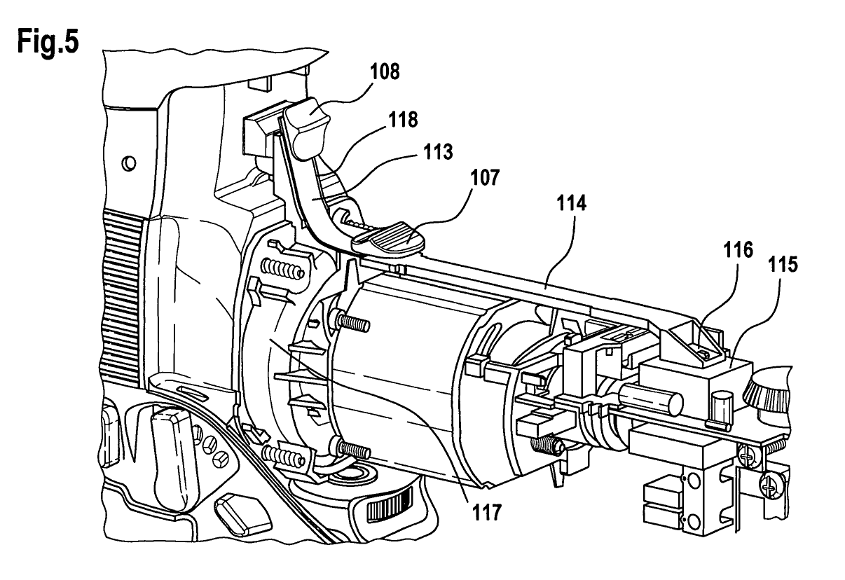

FIG. 5 is a further perspective detained view similar to FIG. 4. The guide of sheet-metal connecting piece 113 is shown in this figure. Sheet-metal connecting piece 113 is guided inside housing shell 111 (refer to FIG. 1) of jigsaw 100 and with cover disc 117 of jigsaw 100. In particular, a ramp or a slanted surface 118 is provided, on which sheet-metal connecting piece 113 rests.

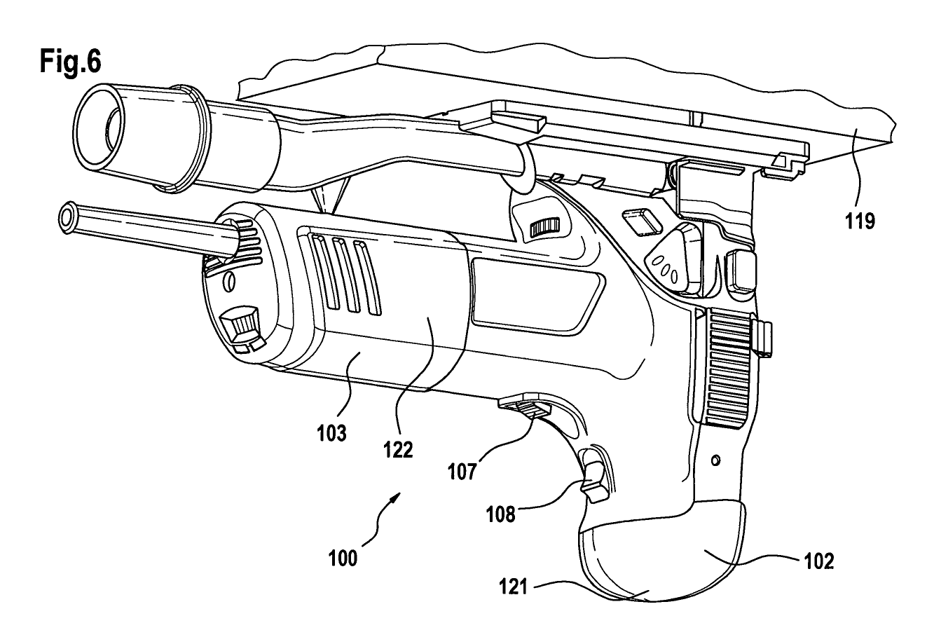

FIG. 6 shows jigsaw 100 overhead. Jigsaw 100 is seated against a wood ceiling 119 to be machined.

The mode of operation of duplicate switch 107, 108 will be explained below with reference to FIG. 5.

Jigsaw 100 can be turned on and off using either first operating switch 107 or second operating switch 108. If first operating switch 107 is operated, second operating switch 108 is simultaneously moved by sheet-metal connecting piece 118. Adjusting slide 114 is also displaced. Adjusting slide 114 acts on electronics 115 via its front section 116, so that jigsaw 100 is turned on or off. If second operating switch 108 is operated, the switching motion is transferred by flexible sheet-metal connecting piece 118 to first operating switch 107, which, in turn, transfers the motion to adjusting slide 114.

The use of switches 107 and 108 will now be explained with reference to FIGS. 1 and 6.

FIG. 1 shows the normal operation of jigsaw 100. In this state, an operator intends to cut through a board 101 using jigsaw 100. To do this, the operator places jigsaw 100 on board 101 as shown. He grips a front region 120 of handle 102 with one hand and grips side handle 103 with the other hand, so that the thumb of the latter hand rests on surface 110 of side handle 103. To start sawing, the operator must now turn on jigsaw 100. To do this, he uses first operating switch 107. It is located in the direct vicinity of the thumb that rests on surface 110. Accordingly, jigsaw 100 can be turned on and off using first operating switch 107 by a simple motion of this thumb. First operating switch 107 is therefore located in an optimum position for normal operation of jigsaw 100. When the jigsaw is used overhead, however, first operating switch 107 is very difficult to reach. This will now be described with reference to FIG. 6.

In the case illustrated in FIG. 6, an operator intends to use jigsaw 100 upside-down, so to speak, to machine a wood ceiling 119. To do this, the operator places jigsaw 100 overhead against ceiling 119 as shown. The operator then encloses head 121 of top handle 102 with one hand. The operator encloses handle 103 with the other hand. Since, in this case, side handle 103 is not enclosed with the hand from the side, as in FIG. 1, but rather from the bottom, the operator's thumb rests against one of the two side surfaces 122 of side handle 103. Accordingly, first operating switch 107 is very difficult to reach when the jigsaw is used overhead. For this reason, second operating switch 108 is used to turn jigsaw 100 on and off in the state shown in FIG. 6.

This second operating switch is now located in the direct vicinity of the thumb of the operator's other hand. Thanks to second operating switch 108, the operator can therefore also easily turn jigsaw 100 on and off with the thumb of one hand even when performing overhead work, without having to change his hand positions.

What is claimed is:

1. A power tool with a first operating switch (107) for turning the power tool (100) on and off,
wherein
the power tool (100) includes a second operating switch (108) for turning the power tool on and off.

2. The power tool as recited in claim 1,
wherein
the first operating switch (107) and the second operating switch (108) are positioned essentially at right angles to each other.

3. The power tool as recited in claim 1,
wherein
the power tool (100) includes a side handle (103) and a top handle (102), the first operating switch (107) being located on the side handle (103), and the second operating switch (108) being located on the top handle (102).

4. The power tool as recited in claim 3,
wherein
the side handle (103) and the top handle (102) transition into each other, thereby essentially forming a right angle (106), the first operating switch (107) and the second operating switch (108) being located on diametrically opposed surfaces (109, 110) in this angle (106).

5. The power tool as recited in claim 1,
wherein
the first operating switch (107) and the second operating switch (108) are coupled with each other.

6. The power tool as recited in claim 5,
wherein
the first operating switch (107) and the second operating switch (108) are mechanically coupled with each other via a flexible connecting element (113).

7. The power tool as recited in claim 6,
wherein
the connecting element (113) is made of sheet metal.

8. The power tool as recited in claim 6,
wherein
the power tool (100) includes a guide (117, 118) for the connecting element (113).

9. The power tool as recited in claim 1,
wherein
the first operating switch (107) is connected with an adjusting slide (114), the adjusting slide (114) converting a motion of the first operating switch (107) into an electrical variable.

10. The power tool as recited in claim 1,
wherein
the power tool (100) is a jigsaw.
